(19) United States
(12) Patent Application Publication
(10) Pub. No.: US 2009/0007108 A1
(43) Pub. Date: Jan. 1, 2009

(54) Arrangements for hardware and software resource monitoring

(76) Inventor: Ulf R. Hanebutte, Gig Harbor, WA (US)

Correspondence Address: SCHUBERT, OSTERRIEDER & NICKELSON, PLLC;c/o Intellevate, LLC, P.O. BOX 52050, MINNEAPOLIS, MN, 55402, US

(21) Appl. No.: 11/824,378

(22) Filed: Jun. 29, 2007

(51) Int. Cl. G06F 9/455; G06F 9/46

(52) U.S. Cl. 718/1; 718/100; 718/104

(57) ABSTRACT

In one embodiment a method for accounting processing resources expended on an activity is disclosed. The method can include determining a task to be performed by a domain, where the task can utilize at least one hardware resource and at least one software resource. The method can monitor and correlate events that are only visible as hardware events with events that are only visible as software events. In one embodiment, this capability is applied to virtual machine configurations on platform power-managed systems to provided correlated platform performance state characteristics on virtual machine, workload or thread level. The method can also combine an output metric of the hardware monitor with an output metric of the software monitor to provide an accounting of resources utilized by the task.

### FIELD OF INVENTION

The present disclosure is related to the field of electronics and more particularly to the field of monitoring activities of a processing system.

### BACKGROUND

Data processing functions carried out by a computer can generally be viewed as being performed by dedicated hardware resource, by a dedicated software resource, or by a combination thereof. Many factors enter into how and why a designer will blend hardware and software resources to most efficiently accomplish different tasks.

Monitoring the performance of a computing system and resource management of systems based on resource usage and allocation is becoming more and more complex because of this hardware/software trade off and the lack of the ability to monitor whether a task is being processed mainly by hardware or by software. In virtual machine configurations it is also difficult to correlate hardware resource usage with individual virtual machines (commonly referred to as domains) that are processing tasks.

It can be appreciated that, current processing methodologies can utilize multiple processors for a task and multiple computers can work on, or share the processing of the single task or small portions of a larger task. In addition, most of these multiple processor systems can multi-task, running different application software in different processors, such that only a portion of a system is processing an entire task while another portion of the system is processing another separate task. Further, current software allows one computer to parse tasks and send portions of tasks to other computers over the Internet where tasks can again be separated and processed by multiple resources.

In an effort to increase the energy efficiency of computer platforms, power management (PM) capabilities continue to be built into the processor and platform. For example, when a processor runs at high clock speed it consumes significantly more power than when the processor runs at low speeds. Further as processing speeds increase linearly power consumption and other resource consumption can increase exponentially. Such resource consumption can affect battery life and device life particularly when higher operating speeds create high internal temperatures. It can be appreciated that devices often adjust their internal clock speeds according to heat, battery life and other parameters. A well power managed platform is also paramount for AC-powered systems in data centers, since cooling and power deliver costs represent significant portion of data center operating costs. Power management is important in all computing segments, from ultra-mobile computing, desktop computing to servers.

Accounting for resources that are being utilized can also be complex when multiple threads are utilized. A thread generally is a processor activity in a specific process where the single process can have multiple threads. Threads can share process address space and data. Many applications can run multiple threads concurrently. This type of parallelism is found largely in applications written for commercial servers as databases. By running many threads at once, these applications can tolerate the high amounts of I/O and memory system latency their workloads can incur while one thread is delayed waiting for a memory or disk access, other threads can do useful work.

Power management based changes are typically utilized to change a performance state of the system. This dynamic process of managing power of the platform components is typically focused on processors or processor cores. Generally, a lower performance state equates to lower clock speeds and thus lower power consumption. In a multi-processor/multi-core platform, power management is a complex process involving software, firmware and hardware components where all of these components can decide, control and change performance states. These decisions and state changes are often performed by the platform and such changes are often transparent to the operating system within a temporal granularity that is very hard to detect and monitor by any monitoring system.

In other complex computing environments, computers can be configured to operate as virtual machines. In one example, a virtual machine can be though of as a self-contained operating environment within a machine executing a first set of code that behaves as if it is a separate computer when executing a second independent set of code. For example, Java applets can run in a Java virtual machine (VM) that has no access to the host operating system. A virtual machine can also be any multi-user shared-resource operating system that gives each user the appearance of having sole control of all the resources of the system yet the system is being shared among many different users/subscribers. It can be appreciated that monitoring and associating resource consumption and allocating computing resources can be a complex task.

### BRIEF DESCRIPTION OF THE DRAWINGS

Aspects of the invention will become apparent upon reading the following detailed description and upon reference to the accompanying drawings in which, like references may indicate similar elements:

FIG. 1 depicts a block diagram of a processing environment;

FIG. 2 illustrated a block diagram of a virtual machine based processing system;

FIG. 3 depicts a block diagram of a single OS processing system;

FIG. 4 illustrates a flow diagram of a method for accounting for processing resources; and

FIG. 5 flow diagrams of sub tasks carried out in SW and/or HW layers for one embodiment.

### DETAILED DESCRIPTION OF EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present invention may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In accordance with the present disclosure, the arrangements disclosed herein can determine how much time a processor spends in different performance states. Accumulating indicators or data on how much time a processor core spends on a specific task in different discrete performance states can create an accurate accounting of the resources that a particular client or application consumes on a platform. In another embodiment, the system can detect or monitor processing power and “actual” power (current and voltage) consumed by a “subscriber” or an application where the subscriber is being serviced by multiple virtual machines. In addition, arrangements are disclosed that in a virtual machine environment determine how much time each virtual machine or each domain spends in different performance states on each processor.

The disclosed process can be differentiated from traditional systems that count the number of “instruction retired” or count “unhalted cycles.” The results of such a counting arrangement cannot easily be correlated with resource consumption. Further, the disclosed arrangements can correlate processor states and resource consumption with power consumption. In one embodiment disclosed herein, power consumption can be a metric on which to bill a subscriber or resource user. In addition, the disclosed arrangements can be distinguished from embodiments that utilize an average performance counter as the disclosed arrangements provide improved resolution by determining resource consumption of the various performance states as opposed to providing an averaged approximation. Thus, the disclosed arrangements can monitor software activity and hardware activity and accurately account for the processing resources being utilized by a subscriber. The disclosed arrangements can also calculate or make detailed power consumption estimates for operating a virtual machine, performing a workload or a operating at a thread level.

In accordance with one embodiment of the present disclosure, arrangements, methods and apparatuses for accurate processor performance state accounting can be quantified utilizing power consumption as a metric for such accounting. This metric can be supplemented with a software based accounting that provides a software metric. The accounting can be performed on a machine having a single operating system or on a machine that hosts a virtual machine configuration. In accordance with another embodiment, events that are only visible as hardware events can be monitored using a first method and events that are only visible as software events can be monitored using a second method and these two discrete metrics can be combined or added to produce an accounting regarding how much processing power has been/is being utilized by a specific application. Such a configuration can be utilized to track performance state characteristics of a virtual machine, workload or thread.

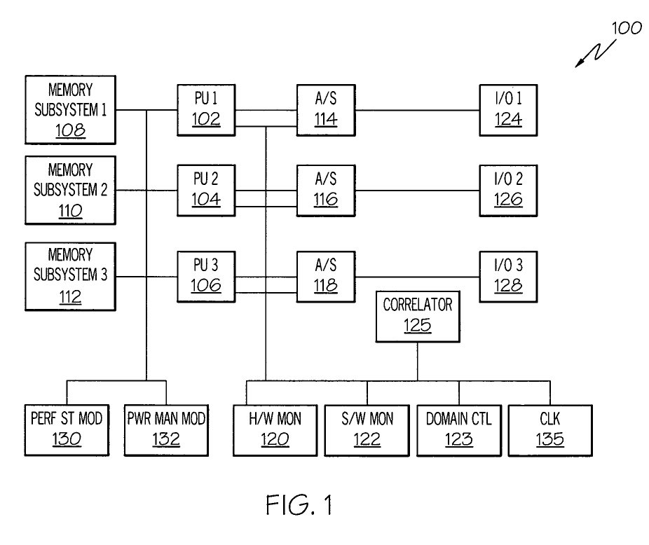

Referring to FIG. 1 a basic computing system 100 is disclosed that has resources useable by subscribers or by application software. The system can include resources such as processing units 102, 104, and 106, memory systems 108, 110 and 112, allocaters-schedulers 114, 116 and 118, input output devices (I/O) 124, 126 and 128, performance state controller module 130, power management module 132, hardware monitor 120, software monitor 122 domain control monitor module 123, correlator 125 and cock 135. The resources of the system 100 can be scheduled/allocated by allocaters-schedulers 114-118. It should be noted, that some of these resources are hardware resources, while others are software resources.

The system 100 can process multiple applications concurrently and the administration of such allocation can be performed by allocaters-schedulers 114-118. Also the system 100 could be distributed where each memory system 108-112, processing unit 102-106, I/O 124-128 etc, is self contained or physically in a separate chassis such as in a separate stand alone computer remotely located from the other components. In operation, the processing units 102-106 can be processing a specific task and the performance state monitor module 130 can monitor and control the performance state of the processors 102-106 and the memory subsystems 108-112.

The power management module 132 can manage the power consumption of the processing units 102-106 based on heat, battery life, processing errors etc. The hardware monitor 120 can monitor how long a processor 102-108 stays in a specific performance state using signals possibly generated by the clock 135 and signals from the performance state module 130. It can be appreciated that in a processing environment such as the one illustrated in FIG. 1, some activity or resource usage can only be monitored, measured, and/or detected by hardware devices such as hardware monitors (i.e. monitor 120) and some resource usage can only be monitored by a software monitor (i.e. monitor 122).

Further, when domains and threads are scheduled and utilized, domain monitor 123 can be monitor such resource allocation and usage as the domain monitor will know what domains are processing specific tasks. Data from these three sources can be sent to the correlator 125 and the correlator can correlate resource usage, ignoring duplicate measurements, and adding separate measurements and partially adding hybrid or non overlapping measurements.

In one embodiment, such as an enhanced halt state (as referred to as a C1E state for specific processors) hardware only visible events can occur in the system. This state can be controlled by performance state module 103 and/or power management module 132. This hardware only visible state will typically be transparent to the operating system software. In this enhanced halt state, the processor can be controlled such that is runs at lower speed. Hence the processor can be on one of many reduce power consumption states.

It can be appreciated that a transition of an operating state from, a C1E state (an enhanced sleep state) to C1 state (an ordinary sleep state) can be controlled by a hardware based power management architecture such as the performance state module 130 and the power management modules 132. Transition from nominal maximum performance state to a “turbo-mode” is an example of hardware controlled performance state. In such a hardware controlled architecture a power management unit in the system (hardware devices 130 and 132) can control performance state changes where other entities such as software cannot detect such a performance change or power consumption change. Accordingly these changes can be transparent to the operating system and transparent to software monitor 122 since this feature is solely a hardware driven function.

Likewise, software driven events can be totally undetectable by hardware devices. Examples of software only visible events can include virtual machine context switching or thread context switching performed by allocaters-schedulers 114-118. Thus, when multiple pieces of hardware (i.e. 102-112) are processing a task, it would be difficult for a hardware monitor 120 to determine what resources are being utilized by which task/thread and the magnitude of the task being performed across multiple hardware devices. This can be further complicated when some hardware resources that are processing a task or a portion of a task may even be remotely located from the hardware monitor 120 making a physical connection and monitoring virtually impossible.

In addition hardware monitors 120 can have a hybrid type connection because often performance state changes are not managed or controlled solely by software but allow for detection by some form of hardware. For example power consumption on a dedicated power bus. Many modern systems utilize hardware mechanisms such as power management module 132 to control the performance state of the processors 102-106. Hardware solutions for power consumption and other phenomena have many advantages. For example, when a computer is locked up and is over heating, a software implementation would not avoid a catastrophic failure where a hardware solution would avoid such a failure. For many reasons, it is likely that some hardware based performance state control will continue to be implemented in future data processing devices.

In one embodiment, power management module 132 can monitor power consumption for many different individual power rails in the system. The power delivery system can be divided such that every subsystem, for example memory subsystem 1 108 and processor 1 102 have a dedicated power rail and power management module 132 can detect how much power is being drawn by these subsystems by sampling power consumption at various intervals or by sampling the power draw at various intervals. The power management module 132 can also monitor a time duration that a power on the rail remains within a specific power delivery limit and store the time spent in each limit/range to provide accurate data on power consumption for each piece of hardware.

In another embodiment, power consumption estimates can be obtained as the sum of power consumption over all power states as determined by correlator 125 of the actual “wall” times or real time possibly based on constant cycles or clock cycles as provided by clock 135 or by the time spent in a performance state multiplied with the average power consumed while the particular hardware is in a specific performance state. Estimating the power consumption based on an average performance state can be accurate if a correlation (possibly a measured correlation) can be made between processor states and power consumption. It can be appreciated that the processor state power consumption curve will typically be a non-linear as higher processor states can consume an exponentially larger amount of power. The disclosed arrangements can be expanded to encompass other platform component/subsystems as well as non-performance states, for example memory transaction counts, network bandwidth utilization, or the amount of disk access can all be correlated with power consumption.

Accordingly, correlator 125 can correlate the outputs values or metrics of the hardware monitor 120, the software monitor 122 and other monitors and based on signals from modules such as the domain controller 123, the performance state monitor 130, and the power management module 132 and provide a combined metric for the cumulative but not overlapping resource usage by a particular user a particular task or a particular subscriber. For example, if the hardware monitor 120 and the software monitor 122 have monitored the same or identical task one of these inputs can be ignored.

When the monitoring has not been on an identical task or a duplicate measurement has been made, but some of the resource monitoring has overlapped, then the overlapping portion of the monitoring can be subtracted to provide an accurate accounting. Also, if the activity metric is in different units, the metrics can be weighted before then are added to provide for an accurate accounting. Thus, the correlator 125 can combine data to provide cumulative data. In addition, the correlator 125 might correlate events that are observed by the hardware monitor 120 with events that are observed by the software monitor 122 in time and space to determine if measurements overlap.

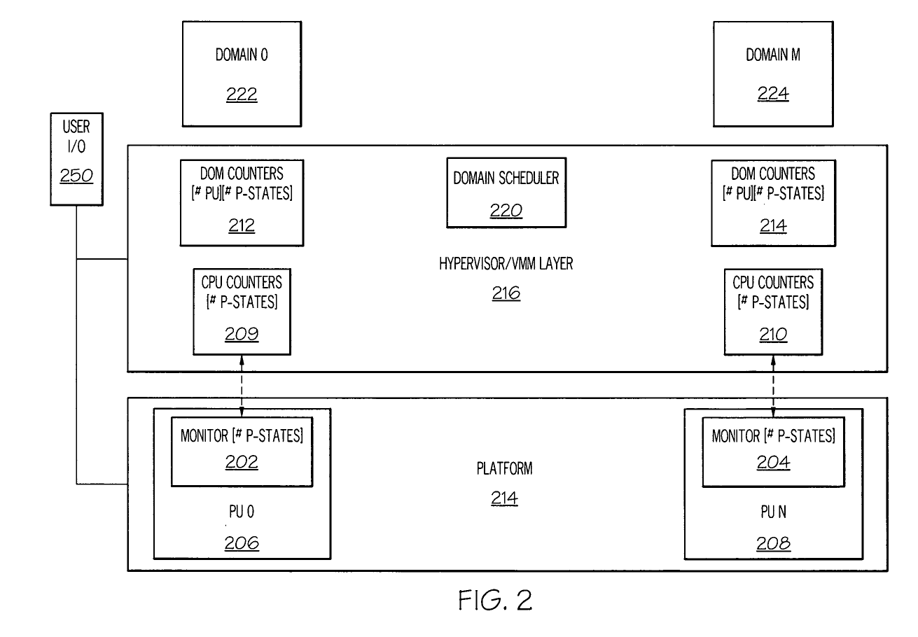

Referring to FIG. 2 an architecture of a virtualized environment/system 200 is depicted where the architecture/platform can contain both hardware and software components. The system 200 can include a platform 214 that contains processor layers 206 through 208 and a hypervisor/virtual machine monitor (VMM) layer 216 that contains a domain scheduler 220 and domain 0 222 through domain M 224. Although only two components are illustrated, the system 200 can be scalable and can contain may more processing units 206-208, than shown, and many more P state counters 209-210, domain counters 212-214 and domains 222-224 than shown.

In one embodiment, hardware monitors 202 and 204 can be located within each processor 206 and 208, while in another embodiment, the hardware monitors 202 and 204 could be centralized possibly within a separate platform component. However, each processor 206 and 208 can have a dedicated monitor 202 and 204 or a dedicated set of monitors. Each monitor 202 and 204 can track processor state or “p-state” entries, and the dedicated processor monitors (p-state hardware monitors 202 and 204) can be a vector of length equal to the number of p-states. P-states can be described as discrete states and a p-state may define a range of clock speeds or a range of power consumptions.

On system or task start up or during a boot procedure, monitors 202 and 204 can be set to zero. The hardware monitors 202 and 204 can be updated locally as events or activities occur such as a transition from one p-state to another p-state. Each p-state monitor entry can also include a relative time or a total time that a processor and its associated resources or support resources spend in the detectable performance state. The time might be determined and stored as a number of constant cycles, i.e. ticks provided by a clock running at a constant clock rate. The hypervisor/VMM 226 can have a domain scheduler 220 to schedule domain execution (i.e. execution of a specific virtual machine) on the platform 214.

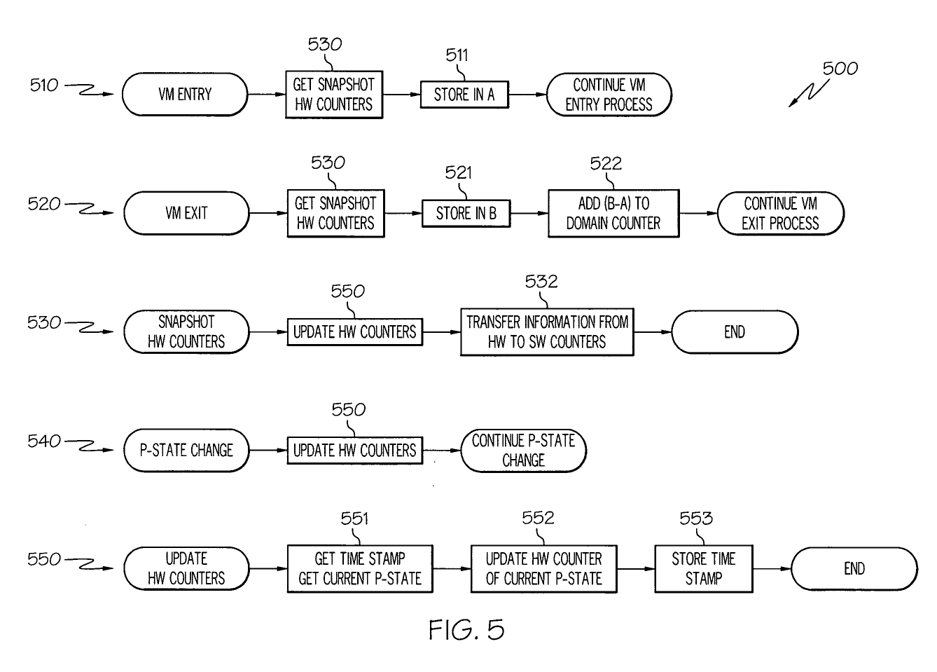

The domain scheduler 220 can be enhanced to provide scheduling information to the monitors 212 and 214. A domain 222 and 224 might be utilizing one or more physical processors, therefore, the domain counters/monitors 212 and 214 can be multi-dimensional. Thus, domain counters/monitors 212 and 214 can contain a two-dimensional data structure to support multiple processing units and multiple p-states. Monitors 202, 204, 209, and 210 can provide an accurate and synchronized monitor framework for activities in process or undertaken by the system 200. This can be accomplished by defining clear roles and responsibilities within the software-hardware stack and the processes of interaction between these stacks. Details of such roles are provided below with regard to FIG. 5.

The user input-output (I/O) module 250 can be utilized to control how the system operates and to get monitoring information back out of the system. For example I/O module 250 can assign monitoring tasks to monitors 202, 204, 209, 210, 212 and 214 and can receive the results of such monitoring and can correlate such results.

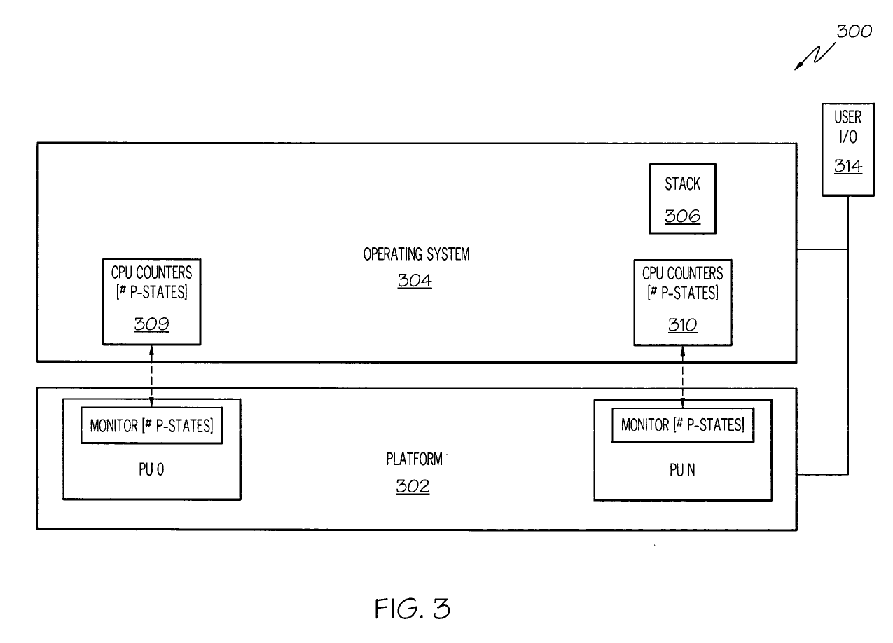

Referring to FIG. 3 a single operating system configuration operating on a platform 300 is illustrated. The configuration can consist of a platform 302 interaction with an operating system 304. The software monitors 210 and 212 of FIG. 2 can be integrated into the hypervisor/virtual machine monitor (VMM) 209 of FIG. 2, and are generally shown as the operating system software stack 306 of FIG. 3. A user interface such as user input/output (I/O) can be capable of running user level code that can query the software monitors or the stack 306 and such a control and retrieval process can be provided by a software function.

The embodiments of FIGS. 2 and 3 can have a user interface or a user I/O module 250 and 314 respectively. The exact implementation of and capability of the user interfaces can depend on the actual hypervisor/VMM 226 or operating system 304 utilized, as well as policies specifying access rights to specific system entities. The operating system 304 (or in FIG. 2 the VMM 209 can have interface/query capabilities that interfaces the systems 200 and 300 with other software metrics and the I/O modules 250 and 314 can monitors existing measurement mechanisms in addition to the monitors described herein and provide output metrics. Prior to a software layer providing the monitor information from all monitored sources, the software layer can perform a monitor update where it retrieves the most recent data from monitors to insure current/accurate values, otherwise the values might be stale and not accurate. The degree of staleness can depend on the specific configuration/use case. The teachings of the present disclosure can be compatible with a “Xen” implementation, where Xen is an open source virtual machine monitor, developed by the University of Cambridge.

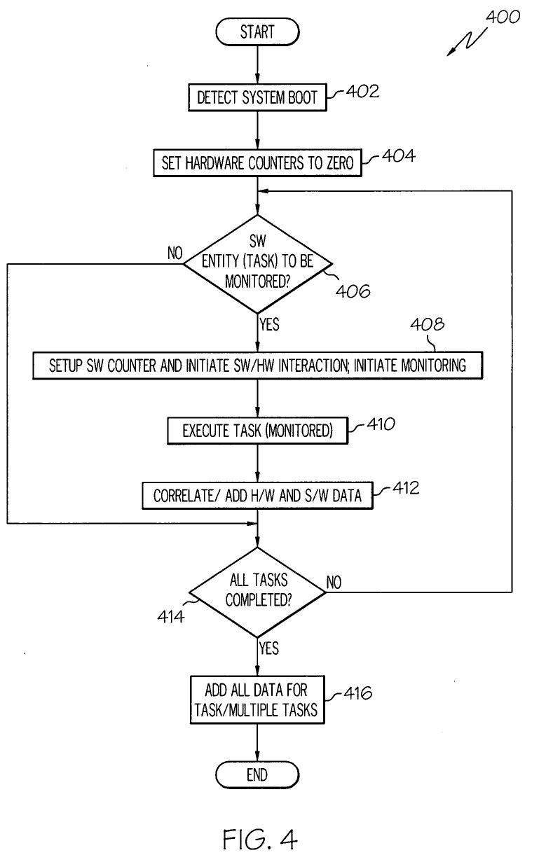

Referring to FIG. 4 a flow diagram is disclosed. As illustrated by block 402, the process can begin as a system boot is detected. As illustrated by block 404, the counters and stored monitor values can be set to zero. The system can detect if a software entity (e.g. a task, thread, virtual machine) should be monitored, as illustrated by decision block 406. If a software resource is to be monitored then monitoring can be initialized by setting up the software counters and by establishing the software-hardware interaction as illustrated in block 408. The resources that have been scheduled and allocated to the task can be monitored as they execute the task as illustrated in block 410. At completion of the task the hardware and software data can be correlated/added as illustrated in block 412. As illustrated by decision block 414, after all tasks, or a predefined set of tasks are completed (414), all data can be combined as indicated in block 416. The process can end thereafter.

For simplicity, the flow diagram 400 does not include algorithmic details within each block and the communication between multi-dimensional counters. However in a power monitoring environment simple addition could be utilized when the monitors can produce equivalent units. The “VM entry” and “VM exit” flow can be carried out within a software layer (typically within a domain scheduler), while a “p-state change” and an “update hardware counter” flow can be executed in software, firmware or hardware depending on the power management architecture of the platform. The system can also obtain a snapshot of a hardware counter to interface between the layers.

The monitors referred to above can be implemented as counters. It can be appreciated that each physical processor can have a local counter and the description provided caters to a more complex case of a virtual environment configuration. Each physical processor can be responsible for updating the hardware counters which track the time spent in each performance state where the number of performance states can be processor architecture dependent. Counters can be managed in at least two distinct ways. First, a counter can be updated at a “constant tick” where the counter is associated with the current performance state. In this configuration the tick granularity and performance state change frequency can impact the accuracy of the result. Accordingly in a second management scheme, each performance state change can be tracked and counters can be updated as part of the performance state change. In addition a capability to update hardware counters during a counter query (i.e. read access) can be utilized such that a sampling procedure can be implemented. When the performance state stays constant over many ticks updating the counter ticks has the advantage that fewer counter updates have to be performed.

In FIG. 5 details of subtasks for one embodiment for virtual environment configuration is disclosed. While flow diagrams 510 and 520 can be within a software layer, flow diagrams 540 and 550 can be executed within a hardware layer, while task 530 can link the software and hardware layers. In a virtual environment configuration that is dependent on the particular software stack, a hypervisor or virtual machine monitor (VMM) can be responsible for scheduling Virtual Machines (i.e. domains). The VMM can have a mapping of virtual processing units (PUs) to physical PU's. When a domain is being scheduled for execution of a specific time slice a “VM entry” function can be called and implemented. When a domain is being de-scheduled a “VM exit” function is being called. Both of these functions can be augmented to interface with the counter subsystem as shown as flow diagrams 510 and 520.

In accordance with diagram 510, at “VM entry” a “snapshot” of data can be taken of the counter set belonging to all processing units that the domain is scheduled to operate on as illustrated by block 530. This snapshot can be stored in the software layer together with a time stamp as illustrated by block 511 and the process can continue. As illustrated by flow diagram 520, at “VM exit” a second snapshot can be taken as illustrated by block 530. This data can be stored as illustrated by block 521. As illustrated by block 522 by subtracting the first snapshot data from the second snapshot data, the actual time spent in each performance state on each processor during the runtime of this domain can being determined, as illustrated in block 522 and the VM exit process can continue. These snapshots can provide a metric of resource consumption and possibly power consumption.

As illustrated by flow 530, the hardware counters can be updated as illustrated in block 550 and the hardware information can be transferred to software counters and the software data and the hardware data can be correlated as illustrated by block 523. The process can end thereafter. As illustrated by flow diagram 540 when a p-state change occurs, the hardware counters can e updated as illustrated by block 550. The system can continue monitoring for p-state changes and update accordingly.

As illustrated by flow diagram 550 to update the hardware counters hardware information can be time stamped and the current p-state can be determined as illustrated by block 551. The hardware counter can be updated to recognize the new or current p-state as illustrated in block 552. The time stamp can be stored as illustrated in block 553 and the process can end there after. In all flow diagrams the data can be added to the appropriate domain counters. The domain counters have been initialized to zero during domain creation and each domain can have its own set of domain counters.

It can be appreciated that having requirements for accurate power management that are hardware based, a processor performance state accounting that is solely based in software cannot accurately characterize resource usage. Thus, the combination of software counters and hardware counters can overcome limitations of traditional devices to provide a correlation between “workload” in a virtual machines and workload from a hardware perspective. The disclosed arrangements enable detailed accounting on domain level, which can be used for improved (energy optimized) domain scheduling by the VMM and for identifying domain interference.

The hardware counters can be implemented in a low overhead configuration. Compared to a constant or statistical sampling from within the user space (e.g. one could query processor frequency), the disclosed arrangements provides more accurate accounting data with a reduced overhead. Cost models can be developed based on the metrics disclosed herein to assign a “power consumption cost” to a workload or a particular task executed within a virtual machine. This information can be provided to data center management software and thus could be utilized for billing subscribers based on an accurate determination of the magnitude of resources allocate to a particular task and to a particular subscriber that has had multiple tasks serviced. The information could also be utilized to provide better allocation of resources. Future processors might not correlate a performance state with one particular clock or processing frequency, rather with a certain level of service, and the arrangements disclosed herein can support such a generalization.

As stated above, an accounting in a software-hardware based architecture in a virtualization environment and for a single operating system can be implemented. In this virtualization environment, the hardware counters can be located within each processor and software counters can be integrated in a hypervisor and/or a VMM software stack. Additional per domain counters can be utilized in the software to track the time spent in each domain. A domain might be utilizing one or more physical processors; therefore, the domain counters can be multi-dimensional. Any hypervisor/VMM can require a domain scheduler, to schedule domain execution on the platform. The domain scheduler can provide scheduling information to the new counter subsystem. In a single operating system embodiment, the hardware counters can be located within each processor and corresponding software counters can be integrated in the operating system software stack. In another embodiment, the HW counters could be centralized on a separate platform component.

Assuming all processors must or do run at the same speed a measurement of resource usage may include data such as for twenty minutes 54% of the time four processors operate at the highest frequency (P0), while thirty percent of the time the four processors operated at a middle frequency and 6% of the time was spent at the lowest frequency (P3). In another embodiment where processor can run at different speeds different P-state distributions for each PU could be provided as a system output. The data provided as an output allows accurate association of time spent in each p-state of each processor with each individual domain. The disclosed arrangements can be integrated into many different platforms.

The disclosed arrangements provide data that can be exploited by VMM and operating system vendors, original equipment manufacturers, system integrators and data center management software vendors. The disclosed arrangements support a generalization of processor performance states (not just performance state=frequency) and provides to the operating system and VMM and user space (if warranted) accounting capability. Accurately correlate events that are only visible within the hardware with events that are only visible in software can be performed in order to track performance state characteristics of a virtual machine, workload or thread. Find grain accounting can be achieved based on actual time spent in each performance state of each processor by each virtual machine (i.e. domain). Combining hardware and software counters by creating a separation of responsibilities between software and hardware layers can also provide improved accuracy when compared to traditional monitors.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present invention, represent embodiments of the present disclosure.

The disclosed embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods, systems, and media that can create the above mentioned features. It is understood that the form of the invention shown and described in the detailed description and the drawings are to be taken merely as examples. It is intended that the following claims be interpreted broadly to embrace all the variations of the example embodiments disclosed.

What is claimed is:

1. A method comprising:
determining a task to be performed by a processing system the task to utilize at least one hardware resource and at least one software resource;
using a hardware monitor to monitor an indicator of power consumption and to produce a first output metric;
using a software monitor to monitor activity of the at least one software resource and to produce a second output metric; and
correlating the first output metric with the second output metric to provide an accounting of resources utilized by the task.

2. The method of claim 1, wherein the first output metric comprises a processor state count.

3. The method of claim 1, wherein correlating comprises adding, at least partially, the first output metric with the second output metric to provide the accounting of the resources utilized.

4. The method of claim 1, wherein correlating comprises weighting one of the first metric or the second metric and adding the first metric to the second metric.

5. The method of claim 1, further comprising allocating the task to at least one domain and utilizing a domain monitor to monitor activity of the at least one domain, the at least one domain creating at least one of a virtual machine, a thread or a quantifiable workload.

6. The method of claim 1, further comprising billing a subscriber based on the accounting.

7. The method of claim 1, wherein the indicator of power consumption is a power consumption measurement.

8. The method of claim 1, wherein the at least one hardware resource and the at least one software resource are executed in a virtual environment.

9. The method of claim 1, further comprising managing resource allocation of the task based on the accounting.

10. A system comprising:
a hardware based monitor to monitor hardware activity of at least one hardware device the hardware device to process a task and to produce a hardware resource consumption metric base on power consumption;
a software based monitor to monitor at least one software process to process a task and to produce a software resource consumption metric based on a p-state;
a correlator to correlate the hardware resource consumption metric with the software resource consumption metric and to provide an accounting for the activity.

11. The system of claim 10, further comprising:
a domain scheduler coupled to the correlator to assign a task to a domain;
a domain monitor to monitor domain activity, where the correlator can correlate the monitored domain activity into the accounting.

12. The system of claim 10, wherein the hardware based monitor is a performance state counter to determine a duration that a processor spends in a range of clock speeds.

13. The system of claim 10, wherein monitoring the hardware activity further comprises determining a processing speed and a time duration that the processing spends at the processing speed

14. The system of claim 10, wherein the correlator weights results of the monitored hardware activity with results of the monitored domain activity.

15. The system of claim 10, wherein hardware activity monitoring comprises monitor a state where a state comprises a predetermined clock speed for a monitored duration of time in.
